(19) United States
(12) Patent Application Publication
(10) Pub. No.: US 2023/0133804 A1
(43) Pub. Date: May 4, 2023

(54) DISPLAY FIXING STRUCTURE

(71) Applicant: Darwin Precisions Corporation, Hsinchu County (TW)

(72) Inventors: Yu-Tsung SU, Hsinchu County (TW); Chia-Hsin CHANG, Hsinchu County (TW); Yu-Jen LAI, Hsinchu County (TW); Keng-Kuei LIANG, Hsinchu County (TW)

(21) Appl. No.: 17/564,468

(22) Filed: Dec. 29, 2021

(30) Foreign Application Priority Data
Nov. 4, 2021 (TW) 110141232

(51) Int. Cl. G06F 1/16

(52) U.S. Cl. CPC G06F 1/1637

(57) ABSTRACT

A display fixing structure includes a display and a plurality of fixing pieces. The display includes a main body and a protruding portion. The main body includes an outer surface and a plurality of fixing portions. The fixing portions are located on the outer surface. The protruding portion is disposed on the outer surface and separated from the fixing portions. The protruding portion is configured to abut against a wall. The fixing pieces are respectively configured to connect with the corresponding fixing portion and press against the wall.

### RELATED APPLICATIONS

This application claims priority to Taiwanese Application Serial Number 110141232 filed Nov. 04, 2021, which is herein incorporated by reference.

### BACKGROUND

### Technical Field

The present disclosure relates to display fixing structures.

### Description of Related Art

With the continuous improvement of the living standards nowadays, application of electronic products has become an indispensable part of life. Among different choices, the electronic products with display function have become more and more popular. Correspondingly, with the rapid advancement of technology, the demand and expectation of people to the electronic products has also been increasing.

As a result, for some display apparatus to be installed on a wall, apart from working hard to maintain the overall appearance after the installation of the electronic apparatus, the way to simplify the installation process in order to reduce the time and cost involved is undoubtedly an important direction of development of the industry.

### SUMMARY

A technical aspect of the present disclosure is to provide a display fixing structure, which can allow a user to install and fix a display on a wall in a simple and easy manner, while the appearance and the structural integrity of the wall can be maintained.

According to an embodiment of the present disclosure, a display fixing structure includes a display and a plurality of fixing pieces. The display includes a main body and a protruding portion. The main body includes an outer surface and a plurality of fixing portions. The fixing portions are located on the outer surface. The protruding portion is disposed on the outer surface and separated from the fixing portions. The protruding portion is configured to abut against a wall. The fixing pieces are respectively configured to connect with the corresponding fixing portion and press against the wall.

In one or more embodiments of the present disclosure, each of the fixing portions has a hole. Each of the fixing pieces includes an inserting portion and a pressing portion connected with the inserting portion. The inserting portion is configured to at least partially insert into the corresponding hole. The pressing portion at least partially protrudes towards the protruding portion relative to the inserting portion and is configured to press against the wall.

In one or more embodiments of the present disclosure, a depth of each of the holes at least partially extends along an installation direction. Each of the pressing portions at least partially protrudes towards the protruding portion along a pressing direction relative to the corresponding inserting portion. The installation direction is substantially perpendicular to the pressing direction.

In one or more embodiments of the present disclosure, each of the pressing portions includes a first coupling portion. The corresponding inserting portion includes a second coupling portion. The second coupling portion is mutually coupled with the first coupling portion along the pressing direction.

In one or more embodiments of the present disclosure, each of the inserting portions and the corresponding pressing portion are an integrally-formed structure.

In one or more embodiments of the present disclosure, the main body includes a first surface and a second surface opposite to the first surface. The outer surface is located between the first surface and the second surface. The main body further includes a plurality of first buckling portions. The first buckling portions are located on the first surface. Each of the fixing pieces further includes a second buckling portion. Each of the pressing portions is connected between the corresponding inserting portion and the corresponding second buckling portion. Each of the second buckling portions is configured to mutually buckle with the corresponding first buckling portion.

In one or more embodiments of the present disclosure, each of the inserting portions, the corresponding pressing portion and the corresponding second buckling portion are an integrally-formed structure.

In one or more embodiments of the present disclosure, the display includes a screen located on the second surface.

In one or more embodiments of the present disclosure, each of the fixing pieces further includes an anti-slip pad at least partially disposed on a side of the corresponding pressing portion facing to the protruding portion.

In one or more embodiments of the present disclosure, each of the fixing portions further includes a first connecting portion disposed inside the corresponding hole. Each of the fixing pieces further includes a second connecting portion disposed on the corresponding inserting portion. The second connecting portion is configured to mutually connect with the first connecting portion.

In one or more embodiments of the present disclosure, each of the fixing portions further includes a first restricting portion disposed inside the corresponding hole. Each of the fixing pieces further includes a second restricting portion disposed on the corresponding inserting portion. The second restricting portion is configured to mutually restrict with the first restricting portion.

The above-mentioned embodiments of the present disclosure have at least the following advantages:
(1) Since the method to fix the display on the wall is carried out by sandwiching the wall between the protruding portion of the display and the fixing pieces. In this way, it is unnecessary for a user to carry out in advance any processing work such as drilling to the wall. Thus, the appearance and the structural integrity of the wall can be maintained.
(2) The process to connect each of the fixing pieces to the corresponding fixing portion, and to press the pressing portion of each of the fixing pieces to the wall, in order to fix the display to the wall, is simple and easy. Moreover, no additional tool is required in the process. Therefore, it is convenient to the user.
(3) The inserting portion of each of the fixing pieces is at least partially inserted into the corresponding hole, in order to press the corresponding pressing portion against the wall. Therefore, when the wall is relatively thicker, the pressing portion of each of the fixing pieces can be elastically deformed in a suitable magnitude relative to the corresponding inserting portion, such that the wall is sandwiched between the protruding portion of the display and the pressing portions of the fixing pieces. In other words, the display fixing structure can be applied to the wall of different thicknesses. Therefore, it is convenient to the user.

### BRIEF DESCRIPTION OF THE DRAWINGS

The disclosure can be more fully understood by reading the following detailed description of the embodiments, with reference made to the accompanying drawings as follows:

FIG. 1 is a schematic view of application of a display fixing structure according to an embodiment of the present disclosure;

FIG. 2 is a cross-sectional view of application of the display fixing structure of FIG. 1;

FIG. 3 of an exploded back view of the display fixing structure of FIG. 1;

FIG. 4 is an enlarged schematic view of one of the fixing pieces of FIG. 3;

FIG. 5 is a partially enlarged view of the connection between one of the fixing pieces and the corresponding fixing portion of FIG. 4;

FIG. 6 is a cross-sectional view of application of the display fixing structure of FIG. 1, in which the wall is relatively thicker;

FIG. 7 is a cross-sectional view of application of a display fixing structure according to another embodiment of the present disclosure; and

FIG. 8 is a cross-sectional view of application of a display fixing structure according to a further embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

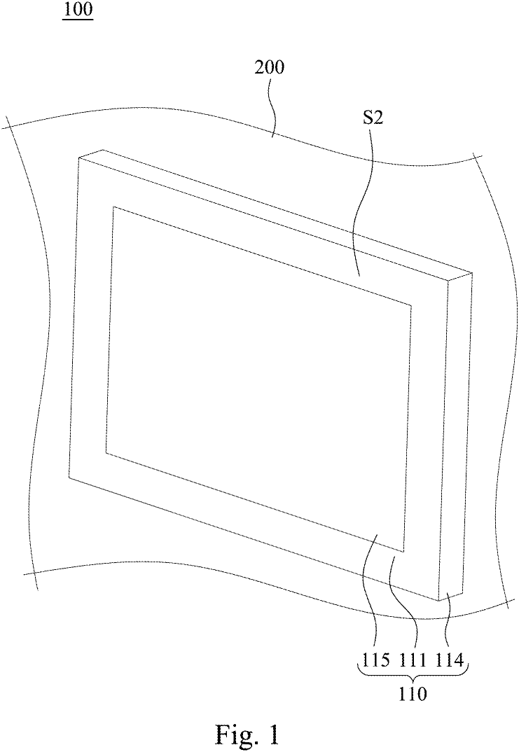

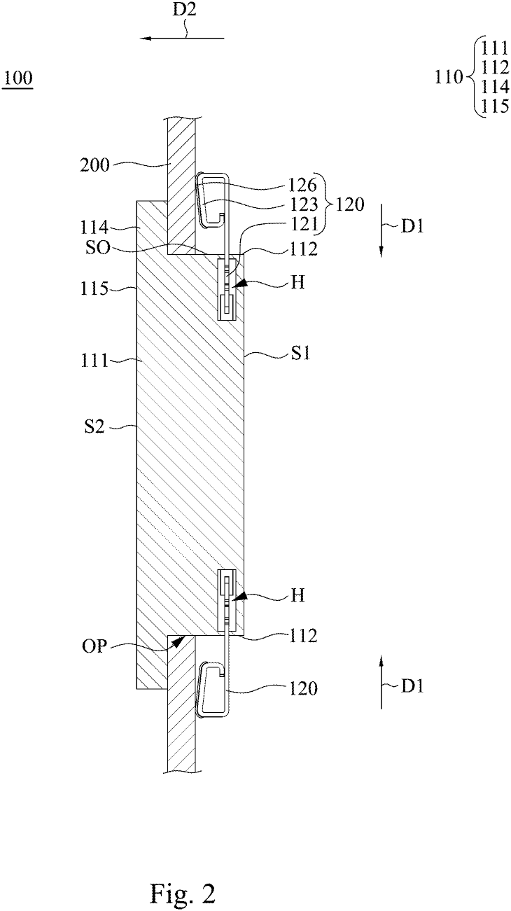

Reference is made to FIGS. 1-2. FIG. 1 is a schematic view of application of a display fixing structure 100 according to an embodiment of the present disclosure. FIG. 2 is a cross-sectional view of application of the display fixing structure 100 of FIG. 1. In this embodiment, as shown in FIGS. 1-2, a display fixing structure 100 is configured to install and fix on a wall 200. To be specific, the display fixing structure 100 includes a display 110 and a plurality of fixing pieces 120. The display 110 includes a main body 111 and a protruding portion 114. The main body 111 is at least partially located in an opening OP of the wall 200. The main body 111 includes an outer surface SO and a plurality of fixing portions 112. The fixing portions 112 are located on the outer surface SO. The protruding portion 114 is also disposed on the outer surface SO and separated from the fixing portions 112. To be specific, the protruding portion 114 of the display 110 is configured to abut against a side of the wall 200. The fixing pieces 120 are respectively configured to connect with the corresponding fixing portion 112 and press against another side of the wall 200, such that the display 110 can be fixed on the wall 200.

It is worth to note that, in this embodiment, the method to fix the display 110 on the wall 200 is carried out by sandwiching the wall 200 between the protruding portion 114 of the display 110 and the fixing pieces 120. In this way, it is unnecessary for a user to carry out in advance any processing procedure such as drilling to the wall 200. Thus, the appearance and the structural integrity of the wall 200 can be maintained.

To be specific, as shown in FIG. 2, each of the fixing portions 112 has a hole H. A depth of each of the holes H at least partially extends along its individual installation direction D1. The installation directions D1 are substantially parallel with a surface of the wall 200.

In addition, the main body 111 includes a first surface S1 and a second surface S2 opposite to the first surface S1. The outer surface SO of the main body 111 is located between the first surface S1 and the second surface S2. Moreover, the display 110 includes a screen 115. The screen 115 is located on the second surface S2 of the main body 111.

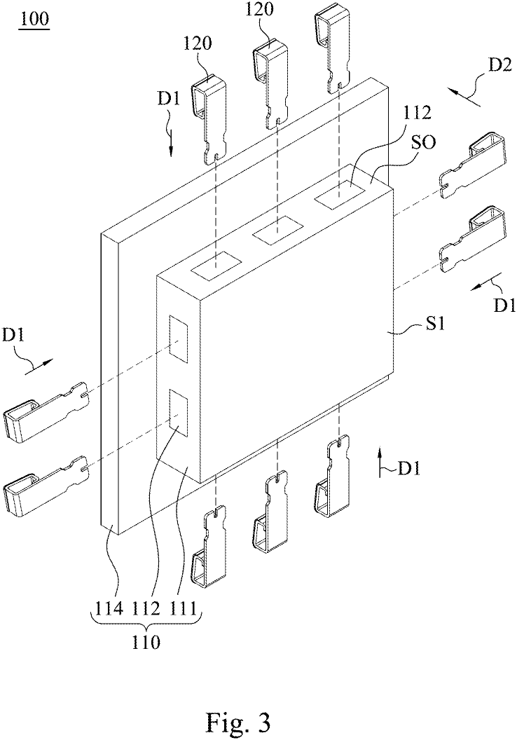

Reference is made to FIG. 3. FIG. 3 of an exploded back view of the display fixing structure 100 of FIG. 1. In this embodiment, as shown in FIG. 3, the outer surface SO of the main body 111 extends along a perimeter of the first surface S1, such that the outer surface SO at least partially surrounds the main body 111 of the display 110. It is worth to note that, the fixing portions 112 are separated from each other and are distributed on different aspects of the outer surface SO. For example, as shown in FIG. 3, the display 110 has at least partially a rectangular shape, and the fixing pieces 120 are respectively connected with the corresponding fixing portion 112 relative to the display 110 along the individual installation direction D1 at four different aspects. Thus, the stability of the display 110 to be fixed on the wall 200 is further enhanced.

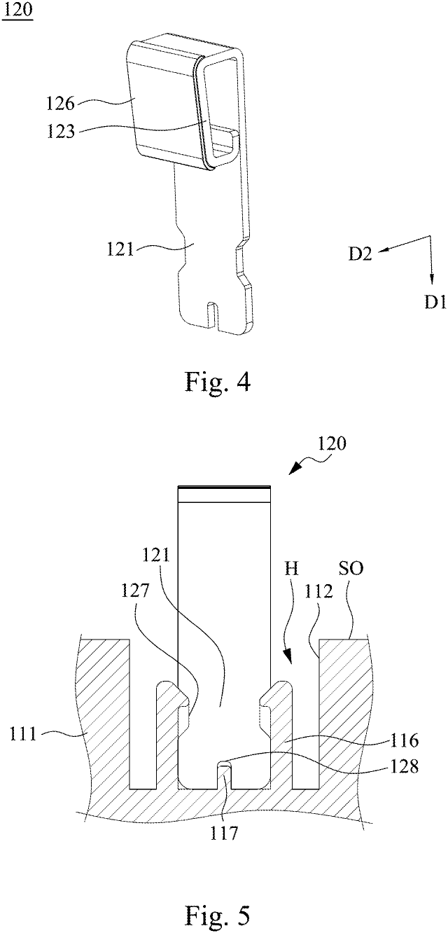

Reference is made to FIG. 4. FIG. 4 is an enlarged schematic view of one of the fixing pieces 120 of FIG. 3. In this embodiment, as shown in FIG. 4, each of the fixing pieces 120 includes an inserting portion 121 and a pressing portion 123 connected with the inserting portion 121. The inserting portion 121 is configured to at least partially insert into the corresponding hole H (please refer to FIG. 2 for the holes H). The pressing portion 123 at least partially protrudes towards the protruding portion 114 (please refer to FIGS. 2-3 for the protruding portion 114) relative to the inserting portion 121 and is configured to press against the wall 200.

To be more specific, as shown in FIGS. 2-4, each of the pressing portions 123 of the fixing pieces 120 at least partially protrudes towards the protruding portion 114 of the display 110 along a pressing direction D2 relative to the corresponding inserting portion 121. The installation direction D1 is substantially perpendicular to the pressing direction D2. The process to connect each of the fixing pieces 120 to the corresponding fixing portion 112, and to press the pressing portion 123 of each of the fixing pieces 120 against the wall 200, in order to fix the display 110 to the wall 200, is simple and easy. Moreover, no additional tool is required in the process. Therefore, it is convenient to the user.

In addition, in this embodiment, as shown in FIG. 4, the inserting portion 121 of each of the fixing pieces 120 and the corresponding pressing portion 123 are an integrally-formed structure. In other words, each of the fixing pieces 120 is fabricated from a single piece of material. Thus, the structural strength of each of the fixing pieces 120 is effectively enhanced.

Moreover, according to the actual situations, as shown in FIG. 4, each of the fixing pieces 120 further includes an anti-slip pad 126. Each of the anti-slip pads 126 is at least partially disposed on a side of the corresponding pressing portion 123 facing to the protruding portion 114 (please refer to FIGS. 1-3 for the protruding portion 114). When the fixing pieces 120 press against the wall 200, the anti-slip pads 126 disposed on the pressing portions 123 press against the wall 200, in order to prevent the fixing pieces 120 from sliding relative to the wall 200. Thus, the stability of the display 110 to be fixed on the wall 200 is further enhanced.

Reference is made to FIG. 5. FIG. 5 is a partially enlarged view of the connection between one of the fixing pieces 120 and the corresponding fixing portion 112 of FIG. 4. In this embodiment, as shown in FIG. 5, each of the fixing portions 112 further includes a first connecting portion 116. Each of the first connecting portions 116 is disposed inside the corresponding hole H. Correspondingly, each of the fixing pieces 120 further includes a second connecting portion 127. Each of the second connecting portions 127 is disposed on the corresponding inserting portion 121. To be specific, the second connecting portion 127 of each of the fixing pieces 120 is configured to mutually connect with the first connecting portion 116 of the corresponding fixing portion 112, such that each of the fixing pieces 120 is mutually connected with the corresponding fixing portion 112. In practical applications, for example, the first connecting portion 116 of the each of the fixing portions 112 can be a pair of hook structures, while the second connecting portion 127 of each of the fixing pieces 120 can be a pair of grooves, such that the hook structures can be snapped to the grooves. However, this does not intend to limit the present disclosure. It is worth to note that, the detachment of the second connecting portion 127 of each of the fixing pieces 120 from the first connecting portion 116 of the corresponding fixing portion 112 can be simply completed by, for example, elastic deformation of the hook structures. No additional tool is required in this process of detachment. Therefore, it is convenient to the user.

Furthermore, in this embodiment, as shown in FIG. 5, each of the fixing portions 112 further includes a first restricting portion 117. Each of the first restricting portions 117 is disposed inside the corresponding hole H. Correspondingly, each of the fixing pieces 120 further includes a second restricting portion 128. Each of the second restricting portions 128 is disposed on the corresponding inserting portion 121. To be specific, the second restricting portion 128 of each of the fixing pieces 120 is configured to mutually restrict with the first restricting portion 117 of the corresponding fixing portion 112, which facilitates the user to connect each of the fixing pieces 120 to the corresponding fixing portion 112.

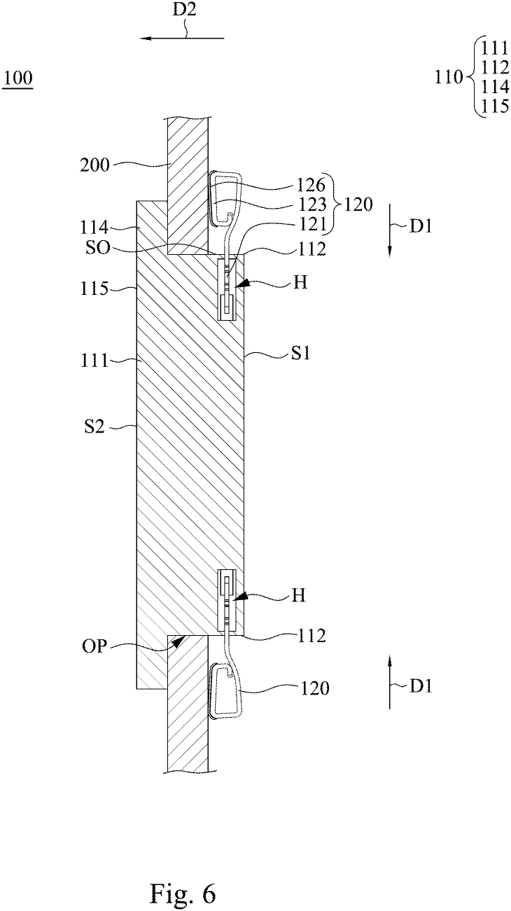

Reference is made to FIG. 6. FIG. 6 is a cross-sectional view of application of the display fixing structure 100 of FIG. 1, in which the wall 200 is relatively thicker. In this embodiment, as shown in FIG. 6, the display 110 is fixed on the wall 200 which is relatively thicker. As mentioned above, the inserting portion 121 of each of the fixing pieces 120 is at least partially inserted into the corresponding hole H, in order to press the corresponding pressing portion 123 against the wall 200. Therefore, in case the wall 200 is relatively thicker, the pressing portion 123 of each of the fixing pieces 120 can be elastically deformed by a suitable magnitude relative to the corresponding inserting portion 121, such that the wall 200 is sandwiched between the protruding portion 114 of the display 110 and the pressing portions 123 of the fixing pieces 120. In other words, the display fixing structure 100 can be applied to the wall 200 of different thicknesses. Therefore, it is convenient to the user.

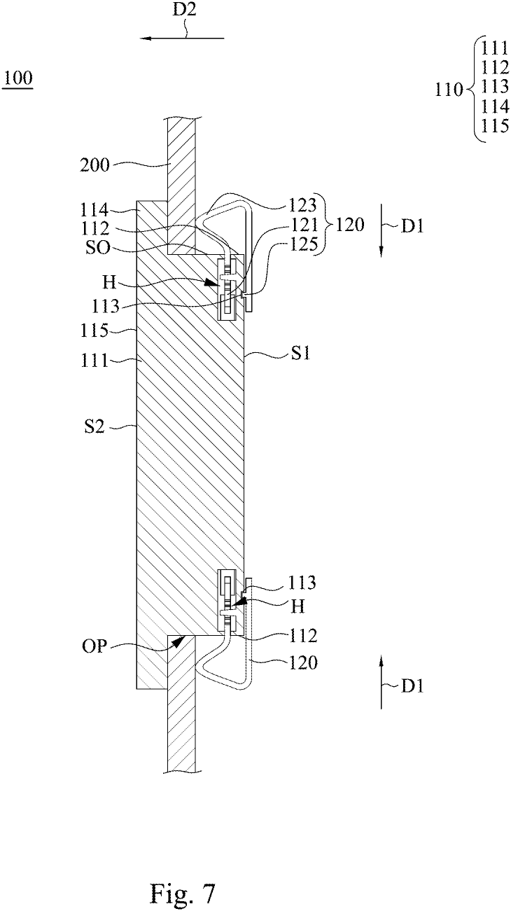

Reference is made to FIG. 7. FIG. 7 is a cross-sectional view of application of a display fixing structure 100 according to another embodiment of the present disclosure. In this embodiment, as shown in FIG. 7, the main body 111 of the display 110 further includes a plurality of first buckling portions 113. The first buckling portions 113 are located on the first surface S1 of the main body 111. Correspondingly, each of the fixing pieces 120 further includes a second buckling portion 125. Each of the pressing portions 123 is connected between the corresponding inserting portion 121 and the corresponding second buckling portion 125. To be specific, the second buckling portion 125 of each of the fixing pieces 120 is configured to mutually buckle with the corresponding first buckling portion 113, in order to prevent the fixing pieces 120 from loosening from the display 110.

In addition, in this embodiment, the inserting portion 121, the corresponding pressing portion 123 and the corresponding second buckling portion 125 of each of the fixing pieces 120 are an integrally-formed structure. In other words, each of the fixing pieces 120 is fabricated from a single piece of material. Thus, the structural strength of each of the fixing pieces 120 is effectively enhanced.

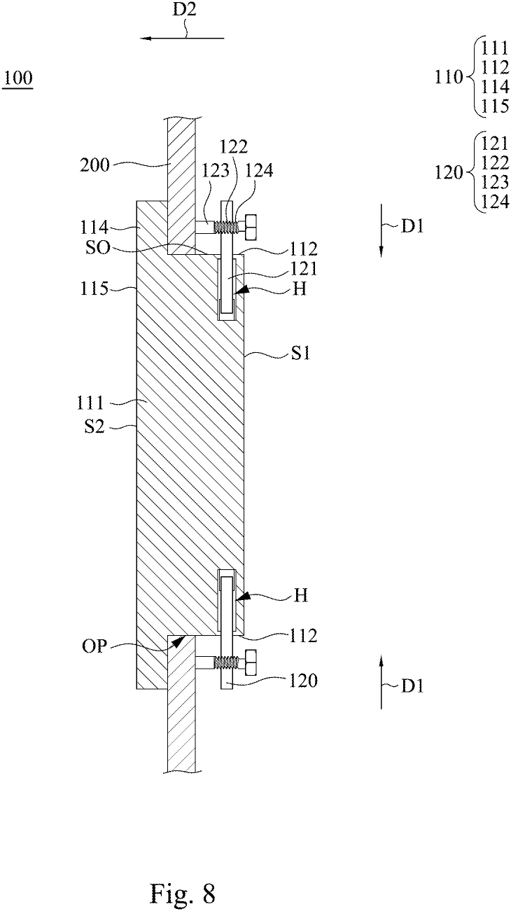

Reference is made to FIG. 8. FIG. 8 is a cross-sectional view of application of a display fixing structure 100 according to a further embodiment of the present disclosure. In this embodiment, as shown in FIG. 8, each of the pressing portions 123 includes a first coupling portion 124. The corresponding inserting portion 121 includes a second coupling portion 122. The second coupling portion 122 is mutually coupled with the first coupling portion 124 along the pressing direction D2. In practical applications, each of the pressing portions 123 can have the form of a screw and the corresponding first coupling portion 124 is an external thread, while the second coupling portion 122 can be a screw hole on the corresponding inserting portion 121. Through the coupling between the external thread and the screw hole, the user can adjust the position of the each of the pressing portions 123 relative to the corresponding inserting portion 121 for the wall 200 of different thicknesses.

In conclusion, the aforementioned embodiments of the present disclosure have at least the following advantages:
(1) Since the method to fix the display on the wall is carried out by sandwiching the wall between the protruding portion of the display and the fixing pieces. In this way, it is unnecessary for a user to carry out in advance any processing work such as drilling to the wall. Thus, the appearance and the structural integrity of the wall can be maintained.
(2) The process to connect each of the fixing pieces to the corresponding fixing portion, and to press the pressing portion of each of the fixing pieces to the wall, in order to fix the display to the wall, is simple and easy. Moreover, no additional tool is required in the process. Therefore, it is convenient to the user.
(3) The inserting portion of each of the fixing pieces is at least partially inserted into the corresponding hole, in order to press the corresponding pressing portion against the wall. Therefore, when the wall is relatively thicker, the pressing portion of each of the fixing pieces can be elastically deformed in a suitable magnitude relative to the corresponding inserting portion, such that the wall is sandwiched between the protruding portion of the display and the pressing portions of the fixing pieces. In other words, the display fixing structure can be applied to the wall of different thicknesses. Therefore, it is convenient to the user.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

1. A display fixing structure, comprising:
a display, comprising:
a main body comprising an outer surface and a plurality of fixing portions, the fixing portions being located on the outer surface; and
a protruding portion disposed on the outer surface and separated from the fixing portions, the protruding portion being configured to abut against a wall; and
a plurality of fixing pieces respectively configured to connect with the corresponding fixing portion and press against the wall.

2. The display fixing structure of claim 1, wherein each of the fixing portions has a hole, each of the fixing pieces comprises an inserting portion and a pressing portion connected with the inserting portion, the inserting portion is configured to at least partially insert into the corresponding hole, the pressing portion at least partially protrudes towards the protruding portion relative to the inserting portion and is configured to press against the wall.

3. The display fixing structure of claim 2, wherein a depth of each of the holes at least partially extends along an installation direction, each of the pressing portions at least partially protrudes towards the protruding portion along a pressing direction relative to the corresponding inserting portion, the installation direction is substantially perpendicular to the pressing direction.

4. The display fixing structure of claim 3, wherein each of the pressing portions comprises a first coupling portion, the corresponding inserting portion comprises a second coupling portion, the second coupling portion is mutually coupled with the first coupling portion along the pressing direction.

5-9. (canceled)

10. The display fixing structure of claim 2, wherein each of the fixing portions further comprises a first connecting portion disposed inside the corresponding hole, each of the fixing pieces further comprises a second connecting portion disposed on the corresponding inserting portion, the second connecting portion is configured to mutually connect with the first connecting portion.

11. The display fixing structure of claim 2, wherein each of the fixing portions further comprises a first restricting portion disposed inside the corresponding hole, each of the fixing pieces further comprises a second restricting portion disposed on the corresponding inserting portion, the second restricting portion is configured to mutually restrict with the first restricting portion.
